(19) United States
(12) Patent Application Publication
(10) Pub. No.: US 2002/0050069 A1
(43) Pub. Date: May 2, 2002

(54) Electronic profile acquisition caliper

(76) Inventor: William E. Mellander, Chesterton, IN (US)

Correspondence Address: HARTMAN & HARTMAN, P.C., 552 EAST 700 NORTH, VALPARAISO, IN, 46383, US

(21) Appl. No.: 10/004,205

(22) Filed: Nov. 1, 2001

Related U.S. Application Data
(60) Provisional application No. 60/245,297, filed on Nov. 2, 2000.

(51) Int. Cl. G01B 5/20

(52) U.S. Cl. 33/551; 33/555.1

(57) ABSTRACT

An electronic profile acquisition system for measuring variations in the diameter of a cylindrical body, such as a roll used in the production of metal and paper sheet products. The system comprises a container mounted on wheels, and to which at least two arm assemblies are pivotally mounted so that the container is beneath the arm assemblies. Each of the arm assemblies comprises arms to which probes are mounted. The container encloses a power supply and data acquisition means for receiving output signals from the probes and storing the output signals as data. Finally, the system includes a computer that is separate from and outside the container for processing the data stored by the data acquisition means and representing the data on a screen.

### CROSS REFERENCE TO RELATED APPLICATIONS

This application claims the benefit of U.S. Provisional Application No. 60/245,297, filed Nov. 2, 2000.

### BACKGROUND OF THE INVENTION

1. Field of the Invention

The present invention generally relates to devices for measuring the contour or profile of a cylindrical body, such as rolls used in the production of sheet products.

2. Description of the Related Art

Cylindrical rolls used to roll sheet products, such as aluminum and paper, are required to have a particular profile in order to obtain a flat rolled product. For this reason, the contours or profiles of such rolls must be accurately measured and variations in diameters along their lengths recorded. Saddle-type micrometers have been widely used for this purpose.

As represented in U.S. Pat. No. 5,088,207 to Betsill et al., saddle micrometers generally include a saddle supported on wheels for rolling (“skating”) along the longitudinal length of a roll, with arms that extend outward and downward from the saddle so as to be located on opposite sides of a roll when the saddle micrometer is placed on top of the roll. The saddle has an open frame with a raised shaft centered on the wheel track and oriented parallel to the direction in which the saddle micrometer skates the length of the roll. The arms are mounted on the shaft by a rocking crossbar. One of the arms supports a counterweight or follower probe, while the second arm carries an indicator probe, such as a dial indicator or an LVDT (linear variable differential transducer). By locating the follower and indicator probes on their respective arms to be diametrically opposite each other relative to the roll, variations in the diameter of the roll can be detected by skating the saddle along the length of the roll. If a dial indicator is used as the indicator probe, the saddle must make stops along the length of the roll to allow manual recording of the dial indicator reading. If an LVDT or other electronic transducer is used, variations in the roll diameter can be continuously recorded electronically. The saddle is preferably equipped with an encoder to measure the distance skated along the length of the roll, and a minicomputer is mounted on the frame to read, record, and present input data from the LVDT and the encoder. Encoder readings are typically taken at 0.1 inch (2.5 mm) intervals, while LVDT readings may be recorded with accuracies on the order of about 0.0001 inch (about 2.5 μm).

Existing saddle micrometers suffer from several problems that involve compromises in weight, rigidity, balance and operation. In terms of weight and rigidity, existing saddle micrometers have taken two approaches: either ignore weight for the sake of rigidity, which results in a unit that operators find difficult to handle but will provide accurate readings; or reduce weight to provide a unit that can be more easily handled, sacrificing rigidity to the extent that imprecise readings may occur. This problem is exacerbated if electronic probes are used, since the unit is constantly in motion as readings are taken. Nonetheless, lighter-weight units have generally been more widely accepted because of the difficulty in handling the heavier, more rigid units.

Existing saddle micrometers are also generally top heavy, with the result that the units are more prone to slip off the top of a roll. The Betsill et al. saddle micrometer is illustrative of a top-heavy unit in which the electronics, including input keys and readouts, are mounted to a frame that projects above the saddle. In the event of slipping of the roll, if a heavier unit is used the unit will probably not be damaged but the operator is at risk of injury. On the other hand, if a lightweight unit slides off a roll, the unit is much more likely to be damaged. Finally, from an operational standpoint, existing units have relied on an onboard minicomputer to acquire and process the collected data. Because of the limited computing power of these minicomputers, many electronic saddle micrometers are a simple unit that is easy to learn and operate, but provides only basic profile information. More advanced units are available that require extensive training to learn and skill to operate. While providing more detailed profile information, roll history and hard copy printout, in practice such enhanced capabilities were rarely used because of the difficulty in learning how to operate the onboard minicomputer.

From the above, it can be seen that it would be desirable if a saddle micrometer were available that overcame the shortcomings of the prior art, including improved rigidity, balance and operational features without incurring excessive weight.

### BRIEF SUMMARY OF THE INVENTION

The present invention provides an electronic profile acquisition system for measuring variations in the diameter of a cylindrical body, such as a roll used in the production of metal and paper sheet products. The system comprises a container having a floor, sidewalls oppositely disposed from each other in a transverse direction of the container, and end walls oppositely disposed from each other in a longitudinal direction of the container. Wheels are mounted to and beneath the container to have an axis of rotation perpendicular to the longitudinal direction of the container at an acute angle to the floor of the container. At least two arm assemblies are pivotally mounted to and over the container, such that the container is beneath the arm assemblies. Each of the arm assemblies comprises arms that project outwardly from the sidewalls at an acute angle to the floor of the container, and each arm assembly pivots in a plane perpendicular to the longitudinal direction of the container. A contact probe is mounted to at least one of the arms of each arm assembly, while electronic linear measurement means for producing electronic output signals are mounted to a second arm of each arm assembly so as to be oppositely-disposed from one of the contact probes. The container encloses a power supply and data acquisition means for receiving the output signals from the electronic linear measurement means and for storing the output signals as data. Finally, the system includes a computer that is separate from and outside the container for processing the data stored by the data acquisition means and for representing the data on a screen. The computer may be connected to the data acquisition means through any suitable means, such as a cable or a wireless electronic communication device.

In view of the above, it can be seen that the electronic profile acquisition system of this invention differs from the saddle-type micrometers of the prior art by enclosing data acquisition hardware within a rigid container that also supports from below the arm assemblies used to acquire the profile readings of a cylindrical body. As such, the acquisition system of this invention eliminates the characteristic saddle of the prior art, as well as the need for a separate electronic unit that in the past has been mounted so as to define the upper profile of a saddle micrometer, resulting in a unit that is top heavy. The container provides improved rigidity relative to weight, while also being located beneath the arm assemblies so as not to negatively affect balance. Finally, by providing the data processing within a computer set apart from the container, the user-friendliness of the acquisition system can be greatly improved without adding weight to that portion of the system that must be readily portable from one cylindrical body to another.

Other objects and advantages of this invention will be better appreciated from the following detailed description.

### BRIEF DESCRIPTION OF THE DRAWINGS

FIG. 1 is an end view of an electronic profile acquisition system in accordance with a preferred embodiment of this invention.

FIG. 2 is a side view of a container of the system shown in FIG. 1.

### DETAILED DESCRIPTION OF THE INVENTION

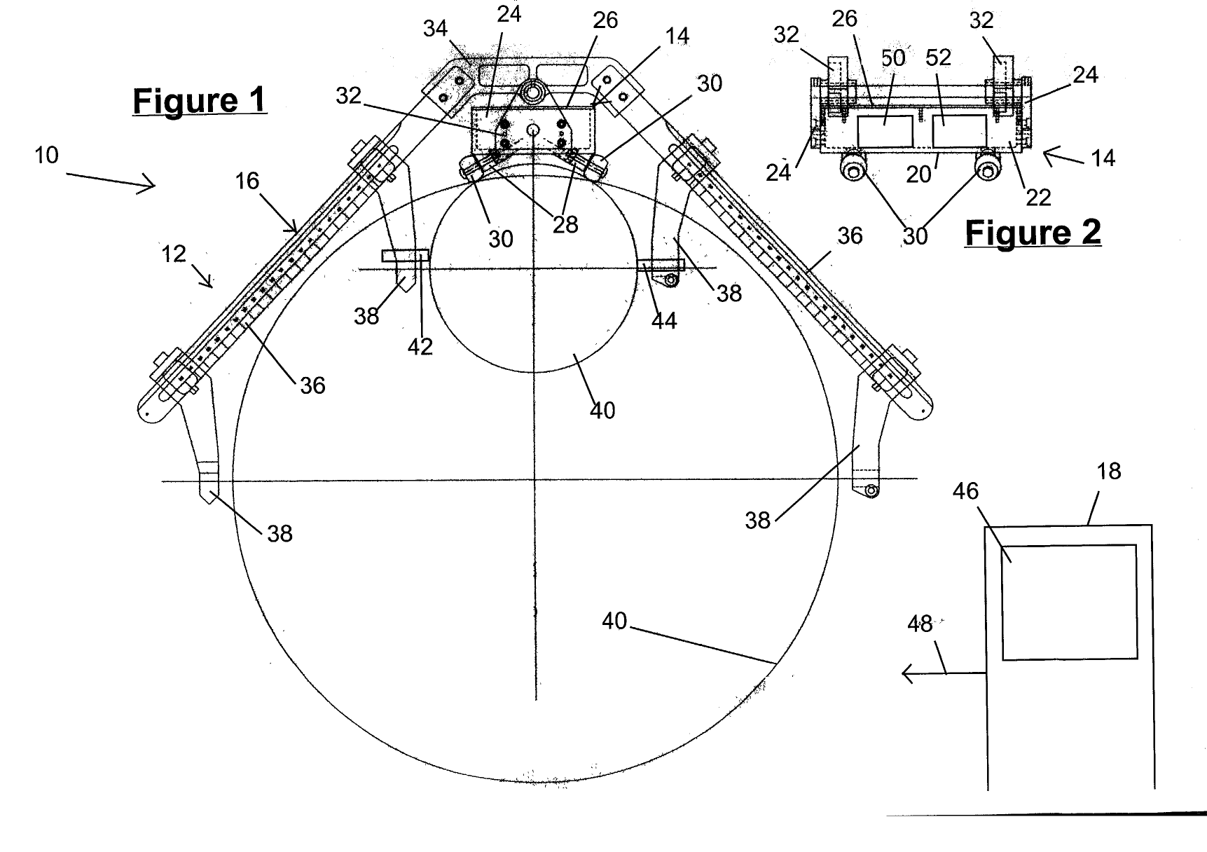

An electronic profile acquisition system 10 in accordance with a preferred embodiment of this invention is shown in FIG. 1. The system 10 can be seen to comprise a portable unit 12 that includes a container 14 and at least one arm assembly 16, and a remote computer 18 such as a PC. As seen in front and side views in FIGS. 1 and 2, respectively, the container 14 has a floor 20, sidewalls 22, end walls 24 and cover 26 that generally define a rectangular box measuring, for example, roughly 17×27×7 cm. The floor 20, sidewalls 22, end walls 24 and cover 26 can all be made of aluminum or another relatively lightweight but rigid structural material. If formed of 6061 aluminum, a suitable thickness for the floor 20, sidewalls 22 and end walls 24 is about 0.6 cm, while a suitable thickness for the cover 26 is about 0.3 cm. The floor 20, sidewalls 22 and end walls 24 are preferably metallurgically joined by welding or brazing, with the cover 26 being removable secured to define an accessible cavity within the container 14.

The container 14 is shown as being equipped with four mounting wedges 28 attached to its floor 20, with a wheel 30 mounted for rotation to each wedge 28 at an angle of about 30 degrees relative to the floor 20. A suitable wheel track, center to center, is about 16 cm and a suitable wheel base is about 19 cm. At least one of the wheels 30 is driven by a suitable motor (not shown) housed within the container 14. In addition, the container 14 preferably houses an encoder (not shown) to measure the distance traveled by the container 14 via sensing rotation of one of the wheels 30 or its shaft.

Each end wall 24 of the container 14 includes a frame 32 to which an arm assembly 16 is pivotally mounted in any suitable manner (only one arm assembly 16 is visible in FIG. 1). Each arm assembly 16 includes a cross arm 34, a pair of scale arms 36 oppositely disposed relative to the cross arm 34, and probe arms 38 adjustably mounted with set screws (or the like) to the scale arms 36. Graduations on the scale arms 36 enable the probe arms

precisely positioned relative to the container 14, as well as a cylindrical body, such as the cylindrical roll 40 on which the unit 12 is shown in FIG. 1 as being placed for use. As seen in FIG. 1, the probe arms 38 are positioned diametrically opposite each other relative to the roll 40. A larger roll 40 is shown in phantom in FIG. 1, showing the probe arms 38 repositioned on the scale arms 38 to accommodate the greater diameter of the larger roll 40. The container 14 allows the unit 12 to be used for a wide range of roll diameters, such as on the order of about 20 to 90 cm. If so desired, extension rails (not shown) can be mounted to the wedges 28, and the wheels 30 mounted to the rails to accommodate much larger rolls 40.

Probes 42 and 44 are represented as being mounted to the probe arms 38 in accordance with known practice. One of the probes 42 is preferably a follower or contact probe intended to make contact with one side of the roll 40, while the second probe 44 is preferably an electronic linear measurement device, such as an LVDT, which generates an electronic signal that, in combination with the contact probe 42, accurately indicates variations in the diameter of the roll 40.

In view of the above, the container 14 can be seen to provide an extremely rigid yet relatively lightweight support frame for the arm assemblies 16, each of which is supported above the container 14 so as to define the upper profile of the unit 12. The container 14 also serves as an enclosure for data acquisition hardware 50 and a suitable power supply, such as a battery 50. As such, the container 14 eliminates the need for a separate hardware and battery enclosure, which in the past has been mounted to project above the arm assemblies (e.g., U.S. Pat. No. 5,088,207). The unit 12 therefore has a very low profile and center of gravity, which equates to better balance when the unit 12 is in use, and therefore improved safety for the unit 12 and its operator. The rigidity of the container 14 promotes the stiffness of the entire unit 12, including the other components of the unit 12 such as the cross bar 34, scale arms 36, and probe arms 38, such that the unit 12 has the mechanical integrity to support state-of-the-art electronics. As the unit 12 skates the roll 40 in the direction of its longitudinal axis, there is no extraneous mechanical motion to distort the electronic readings produced by the indicator probe 44.

Finally, FIG. 1 schematically represents the system 10 as including the computer 18, which is separate from and outside the container 14. The computer 18 preferably utilizes dedicated software to process the data stored by the data acquisition hardware 50 carried by the container 14, and is preferably capable of representing the data on a screen 46. Any suitable communication device 48 can be used to connect the computer 18 to the data acquisition hardware 50 for transferring the data. In one embodiment, the device 48 is a cable, while in another embodiment the device 48 is a wireless module that allows data from the unit 12 to be transmitted to a remote location, such as where the computer 18 is a central terminal anywhere within the complex in which the measurements are being performed. In this aspect, the system 10 of the invention differs from existing saddle micrometers that rely on an onboard minicomputer to acquire and process the acquired data.

According to another preferred aspect of the invention, the computer 18 is provided with touch screen icon-activated functions that are software-driven to receive and display pertinent data quickly, simply, and in a user-friendly format. The touch screen computer

available to the operator an onscreen display of a roll profile skate, which can be projected over a target profile so the operator can see if a roll is within specifications.

In view of the above, the electronic profile acquisition system 10 of this invention provides many capabilities and advantages lacking in prior art saddle micrometers. The container 14 provides a very rigid, low profile unit with a low center of gravity, improving the balance and handling of the portable unit 12. With the computing power of the computer 18, the options for the manipulation and presentation of data become essentially unlimited. Total roll management, including profiling, evaluation, history and inventory, also becomes practical with this invention. The data acquired can be set for different levels of access controlled by passwords (e.g., operator and management). The storage medium of the computer 18 can be readily sized to allow for individual user requirements and subsequent system refinements and upgrades. Using a wireless module as the communication device 48, data from multiple units 12 can be transmitted to a central terminal, where rolls can be evaluated at the corporate, plant site, roll shop, operator and/or grinder level. The inventory and life expectancy of rolls can be monitored, and the history of each roll tracked from the day it is put into service until the end of its useful life.

While the invention has been described in terms of particular embodiments, it is apparent that other forms could be adopted by one skilled in the art. Accordingly, the scope of the invention is to be limited only by the following claims.

1. An electronic profile acquisition system for sensing variations in the diameter of a cylindrical body, the system comprising:
a container having a floor, sidewalls oppositely disposed from each other in a transverse direction of the container, and end walls oppositely disposed from each other in a longitudinal direction of the container;
wheels mounted to and beneath the container to have an axis of rotation perpendicular to the longitudinal direction of the container at an acute angle to the floor of the container;
at least two arm assemblies pivotally mounted to and over the container, each of the arm assemblies comprising arms projecting outwardly from the sidewalls at an acute angle to the floor of the container, each arm assembly being pivotable in a plane perpendicular to the longitudinal direction of the container;
a contact probe mounted to at least a first of the arms of each arm assembly;
electronic linear measurement means for producing electronic output signals, the electronic linear measurement means being mounted to a second of the arms of each arm assembly so as to be oppositely-disposed from one of the contact probes;
data acquisition means for receiving the output signals from the electronic linear measurement means and storing the output signals as data, the data acquisition means being enclosed with the container;
a power supply enclosed with the container;
a computer separate from and outside the container for processing the data stored by the data acquisition means and representing the data on a screen; and
means for connecting the computer to the data acquisition means for transferring the data.

2. A system according to claim 1, wherein the floor, the sidewalls and the end walls of the container are metallurgically joined to each other.

3. A system according to claim 1, wherein the arm assemblies are pivotally mounted to the end walls of the container.

4. A system according to claim 1, wherein the connecting means is a cable.

5. A system according to claim 1, wherein the connecting means is wireless communication device.

6. A system according to claim 1, further comprising a cover attached to the sidewalls and the end walls of the container for enclosing the data acquisition means and the power supply within the container.

7. An electronic profile acquisition system for sensing variations in the diameter of a cylindrical body, the system comprising:
a portable unit comprising:
a container having a floor, sidewalls oppositely disposed from each other in a transverse direction of the container, end walls oppositely disposed from each other in a longitudinal direction of the container, and a cover attached to the sidewalls and the end walls so as to define a cavity within the container;
wheels mounted to and beneath the floor of the container, each of the wheels having an axis of rotation perpendicular to the longitudinal direction of the container and at an acute angle to the floor of the container;
at least two arm assemblies pivotally supported and mounted to the end walls of the container so that the arm assemblies are above the container and define an upper profile of the portable unit, each of the arm assemblies comprising arms projecting outwardly and downwardly from the sidewalls at an acute angle to the floor of the container, each arm assembly being pivotable in a plane perpendicular to the longitudinal direction of the container;
a contact probe mounted to a first of the arms of each arm assembly;
electronic linear measurement means for producing electronic output signals, the electronic linear measurement means being mounted to a second of the arms of each arm assembly so as to be oppositely-disposed from one of the contact probes;
data acquisition means for receiving the output signals from the electronic linear measurement means and storing the output signals as data, the data acquisition means being enclosed with the container; and
a power supply enclosed with the container;
a computer separate from and outside the container for processing the data stored by the data acquisition means and representing the data on a screen; and
means for connecting the computer to the data acquisition means for transferring the data.

8. A system according to claim 7, wherein the floor, the sidewalls and the end walls of the container are metallurgically joined to each other.

9. A system according to claim 7, wherein the connecting means is a cable.

10. A system according to claim 7, wherein the connecting means is wireless communication device.
